(19) United States
(12) Patent Application Publication
(10) Pub. No.: US 2026/0192560 A1
(43) Pub. Date: Jul. 9, 2026

(54) HOT PRESS MACHINE AND WORKING METHOD

(71) Applicant: Hexin Liu, Shenzhen (CN)

(72) Inventor: Hexin Liu, Shenzhen (CN)

(21) Appl. No.: 19/033,832

(22) Filed: Jan. 22, 2025

(30) Foreign Application Priority Data
Jan. 9, 2025 (CN) 202510037724.1

(51) Int. Cl. B41F 16/00; B41F 33/00; B41M 5/03

(52) U.S. Cl. CPC B41F 16/0046; B41F 16/0093; B41F 33/00; B41M 5/03

(57) ABSTRACT

The present disclosure relates to a heat press machine and a working method. The heat press machine includes a base, a support and a heat pressing assembly, wherein the base includes a base body and a support base slidably connected to the base body; the support base is configured to carry a workpiece to be processed; the support is connected to the base; and the heat pressing assembly includes a heat pressing member arranged opposite the support base and a driving member for driving the heat pressing member. When the workpiece is placed by a user, the support base can be driven to slide relative to the base body and move the support base away from the heat pressing assembly, thereby avoiding burns from the heat pressing assembly during the placement of the workpiece to be processed.

### CROSS-REFERENCE TO RELATED APPLICATIONS

The applicaton claims priority of Chinese patent application CN2025100377241,filed on Jan. 9, 2025, which is incorporated herein by reference in its entireties.

### TECHNICAL FIELD

The present disclosure relates to the technical field of heat pressing equipment, particularly to a heat press machine and a working method.

### BACKGROUND

A heat press machine, also known as a hot stamping machine or a heat transfer printer, is a device capable of transferring patterns or text from a heat transfer film onto a workpiece to be processed through thermal pressing.

In existing heat press machines, when a heat press main unit presses different workpieces on the supporting platform, there is often a problem with controlling the pressure, which may result in poor heat transfer printing effects of the patterns or text on the workpiece. Additionally, since heat press machines are commonly used as household appliances in the DIY (Do-It-Yourself) field, some heat press machines use motors, etc. to drive the heat press main unit, which may cause the operator to lack the enjoyment of manual operation.

### SUMMARY

The present disclosure provides a heat press machine and a working method, aiming to solve the problems that the pressure is difficult to control when a heat press main unit presses different workpieces on a supporting platform, and an operator lacks the enjoyment of manual operation.

To solve the above technical problems, the present disclosure adopts the following technical solution:

In a first aspect, the present disclosure provides a heat press machine, comprising:
a base, the base comprising a base body and a support base slidably connected to the base body, and the support base being configured to carry a workpiece to be processed;
a support, the support being connected to the base; and
a heat pressing assembly connected to the end of the support away from the base, wherein the heat pressing assembly comprises a heat pressing member arranged opposite the support base and a driving member configured to drive the heat pressing member, and the driving member is operable manually.

Optionally, further comprising position detection modules, wherein the position detection modules are configured to detect a working position of the heat pressing member.

Optionally, the position detection modules are contact sensors, and the contact sensors are disposed in the driving member; and
when the driving member drives the heat pressing member to move to the working position, at least part of the driving member abuts against the contact sensors.

Optionally, the driving member comprises a housing, a handle, a mounting shaft and a crankshaft structure; and two opposite ends of the mounting shaft respectively pass through the housing, the handle is connected to the two opposite ends of the mounting shaft and is configured for manual operation, two opposite ends of the crankshaft structure are respectively connected to the handle and the heat pressing member, and under the action of an external force, the handle drives the crankshaft structure to move, thereby driving the heat pressing member to approach or move away from the support base.

Optionally, the crankshaft structure comprises crankshafts, a connecting shaft, a connecting rod and a sliding rod; and the crankshafts are sleeved on the mounting shaft, both ends of the connecting shaft in an axial direction are respectively connected to the crankshafts and the connecting rod, the sliding rod is rotatably connected to the end of the connecting rod away from the connecting shaft, and the handle is rotated to drive the heat pressing member to move in a height direction via the crankshafts, the connecting rod and the sliding rod.

Optionally, the positions of the contact sensors are adaptive to the positions of the crankshafts, and when the driving member drives the heat pressing member to move to the working position, at least part of the crankshafts abut against the contact sensors.

Optionally, two crankshafts are provided and respectively located at both ends of the mounting shaft in the axial direction, and two spaced contact sensors are arranged corresponding to each crankshaft.

Optionally, the driving member further comprises a cushioning structure arranged between the sliding rod and the heat pressing member.

Optionally, further comprising an adjusting assembly, wherein two opposite ends of the adjusting assembly are respectively connected to the heat pressing assembly and the support, and the adjusting assembly is configured to adjust a distance between the heat pressing assembly and the support base.

Optionally, the adjusting assembly comprises a screw rod and a knob, the screw rod comprises a connecting end and a threaded end, the threaded end is in threaded connection with the support, and the connecting end passes through one end of the heat pressing assembly and is fixedly connected to the knob.

Optionally, the adjusting assembly comprises a screw rod and a knob, the screw rod comprises a connecting end and a threaded end, the threaded end is in threaded connection with the support, and the connecting end passes through one end of the heat pressing assembly and is fixedly connected to the knob.

Optionally, the base body is provided with sliding rails, the support base is provided with sliding portions adapted to the sliding rails, and the sliding portions slide on the sliding rails to drive the support base to slide relative to the base body; and
the base body is further provided with an in-position detection module, and the in-position detection module is configured to detect the position of the support base relative to the base body.

Optionally, the in-position detection module is a contact sensor, and when the sliding portions slide relative to the sliding rails to drive the support base to slide to a preset position, at least part of the support base abuts against the contact sensor.

Optionally, further comprising:
a signal processor; and/or,
a display screen electrically connected to the signal processor; and/or,
a temperature sensor configured to detect the temperature of the heat pressing member; and/or,
a voice module; and/or,
a lighting module configured to display a lighting effect.

In a second aspect, the present disclosure provides a working method for the heat press machine in the first aspect, comprising the following steps:
driving the support base to move relative to the base body in a direction away from the heat pressing assembly;
placing the workpiece to be processed and a material to be transferred onto the support base, and driving the support base to move in a direction close to the heat pressing assembly; and
manually operating the driving member to drive the heat pressing member to abut against the workpiece to be processed.

Optionally, further comprising a support base in-position reminder step, specifically as follows:
after driving the support base to move in the direction close to the heat pressing assembly, the in-position detection module detects the position of the support base;

If the support base is not in a preset position, the in-position detection module sends a first signal to the signal processor, and the signal processor generates a first information instruction and sends the first information instruction to a corresponding reminder module for execution; and
if the support base reaches the preset position, the in-position detection module does not generate the first signal.

Optionally, further comprising a heat-pressing in-position reminder step, specifically as follows:
after the driving member is manually operated to drive the heat pressing member to abut against the workpiece to be processed, the position detection modules detect the position of the heat pressing member;
if the heat pressing member is not in a working position, the position detection modules send second signals to the signal processor, and the signal processor generates a second information instruction and sends the second information instruction to a corresponding reminder module for execution; and
if the heat pressing member is in the working position, the position detection modules do not generate the second signal.

Optionally, further comprising a residual heat reminder step, specifically as follows:
after the heat pressing member stops heating, a temperature sensor detects the temperature of the heat pressing member and sends a corresponding temperature signal to the signal processor;
if a corresponding temperature is higher than a preset temperature, the signal processor generates a third information instruction and sends the third information instruction to a corresponding reminder module for execution; and
if the corresponding temperature is lower than the preset temperature, the signal processor generates a fourth information instruction and sends the fourth information instruction to a corresponding reminder module for execution.

Optionally, the reminder module is any one or any combination of a voice module, a lighting module, and a display screen.

It can be seen from the above technical solutions that the embodiments of the present disclosure have at least the following advantages and positive effects:

In the heat press machine and the working method of the embodiments of the present disclosure, when a workpiece is placed by a user, the support base can be driven to slide relative to the base body and move the support base away from the heat pressing assembly, thereby avoiding burns from the heat pressing assembly during the placement of the workpiece to be processed; and additionally, the driving member can be manually operated, so that the user can more easily adjust a force of heat pressing according to different workpieces to be processed, while also providing the enjoyment of manual operation.

### DESCRIPTION OF THE DRAWINGS

In order to explain the embodiments of the present disclosure or the technical solutions in the prior art more clearly, the accompanying drawings required by the embodiments or descriptions in the prior art are introduced briefly below. Obviously, the accompanying drawings in the description below are merely embodiments of the present disclosure, and those of ordinary skill in the art can also obtain other accompanying drawings based on the structures illustrated in these accompanying drawings without paying creative work.

FIG. 1 is a schematic view of an overall structure of a heat press machine in a pressing state according to an embodiment of the present disclosure;

FIG. 2 is a schematic view of an overall structure of the heat press machine shown in FIG. 1 in a raised state according to an embodiment of the present disclosure;

FIG. 3 is a schematic view of an overall structure of a support base of the heat press machine shown in FIG. 1 that is pushed and pulled relative to a base body according to an embodiment of the present disclosure;

FIG. 4 is a view of the heat press machine in FIG. 2 at another view angle;

FIG. 5 is a cross-sectional view of the heat press machine along a section line A-A in FIG. 4;

FIG. 6 is a schematic view of the heat press machine with part of the structure omitted in FIG. 1;

FIG. 7 is an exploded structural schematic view of the heat press machine with part of the structure omitted in FIG. 1;

FIG. 8 is a flowchart of a working method for the heat press machine shown in FIG. 1;

FIG. 9 is a flowchart of a heat-pressing in-position reminder in the working method shown in FIG. 8;

FIG. 10 is a flowchart of a support base in-position reminder in the working method shown in FIG. 8;

FIG. 11 is a flowchart of a residual heat reminder in the working method shown in FIG. 8; and

FIG. 12 is a schematic view of the system composition of a heat press machine according to an embodiment of the present disclosure.

### DESCRIPTIONS OF THE REFERENCE SIGNS

10. Heat press machine
100. Base
110. Base body
111. In-position detection module
112. Sliding rail
120. Support base
121. Sliding portion
200. Support
300. Heat pressing assembly
310. Heat pressing member
320. Driving member
321. Housing
322. Handle
323. Mounting shaft
324. Crankshaft structure
3241. Crankshaft
3242. Connecting shaft
3243. Connecting rod
3244. Sliding rod
325. Cushioning structure
3251. Spring
3252. Guide post
330. Position detection module
400. Contact sensor
500. Adjusting assembly
510. Screw rod
511. Connecting end
512. Threaded end
520. Knob
600. Display screen

### DETAILED DESCRIPTION OF EMBODIMENTS

Typical embodiments embodying the features and advantages of the present disclosure will be described in detail in the following description. It is to be understood that the present disclosure is capable of various variations in different embodiments without departing from the scope of the present disclosure, and that the descriptions and drawings therein are intended to be illustrative in nature and are not intended to limit the present disclosure.

Moreover, the terms “first” and “second” are used for descriptive purposes only and are not to be construed as indicating or implying relative importance or implicitly indicating the number of the technical features indicated. Thus, the features defined as “first” or “second” may explicitly or implicitly comprise one or more of the features. In the description of the present disclosure, the meaning of “a plurality of” is two or more, unless specifically defined otherwise.

In the description of the present disclosure, it should be noted that unless otherwise expressly specified and limited, the terms “mount”, “connect” and “attach” should be understood in a broad sense, for example, it may be fixedly connected, detachably connected, or integrally connected, may be mechanically connected or electrically connected, may be directly connected or indirectly connected by means of an intermediate medium, and may also be an internal communication between two components or an interactive relationship between the two elements. Those of ordinary skill in the art can understand the specific meanings of the above terms in the present disclosure in light of specific circumstances.

The present disclosure provides a heat press machine 10 and a working method using the heat press machine. The heat press machine 10 is used for transferring patterns or text from a heat transfer film to a workpiece to be processed through thermal pressing.

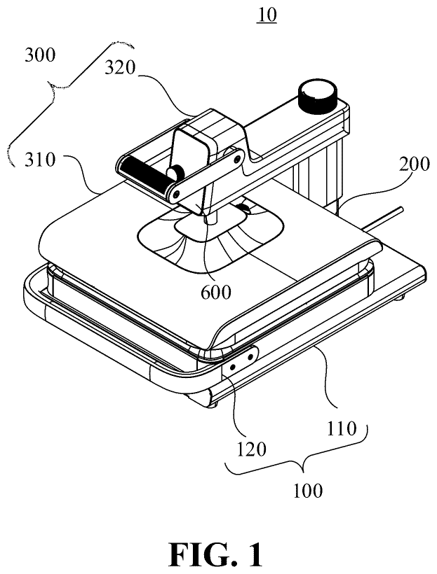

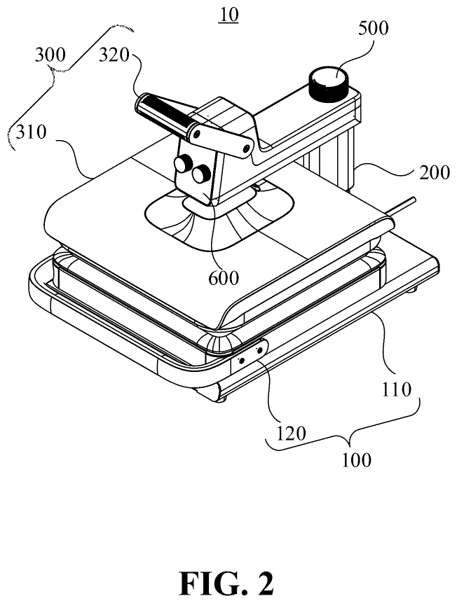

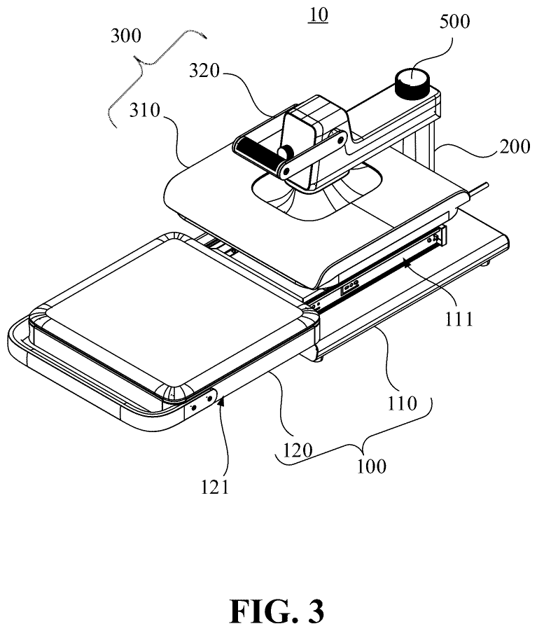

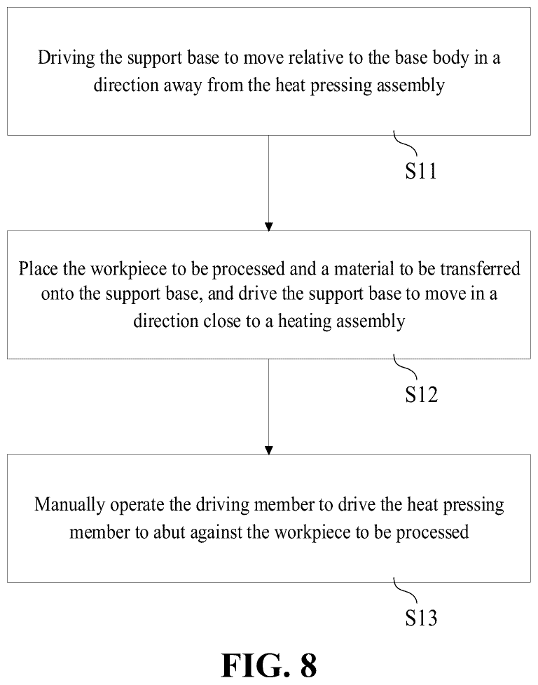

Referring to FIGS. 1, 2, 3 and 8, FIG. 1 illustrates a pressing state of the heat press machine 10, FIG. 2 illustrates a raised state of the heat press machine 10, FIG. 3 illustrates a push-pull state of a support base 120, and FIG. 8 illustrates a flowchart of the working method for the heat press machine 10.

The heat press machine 10 comprises a base 100, a support 200 and a heat pressing assembly 300, where one end of the support 200 is connected to the base 100, and the other end of the support is connected to the heat pressing assembly 300, such that the heat pressing assembly 300 is arranged opposite the base 100. It should be noted that the workpiece to be processed may be paper, textiles, etc.

Specifically, the base 100 comprises a base body 110 and a support base 120 slidably connected to the base body 110, where the support base 120 is configured to carry the workpiece to be processed; and the heat pressing assembly 300 comprises a heat pressing member 310 arranged opposite the support base 120 and a driving member 320 for driving the heat pressing member 310, and the driving member 320 is operable manually.

Referring to FIG. 8, the working method includes the following steps:
Step S11, driving the support base to move relative to the base body in a direction away from the heat pressing assembly;
Step S12, placing the workpiece to be processed and a material to be transferred onto the support base, and driving the support base to move in a direction close to the heat pressing assembly; and
Step S13, manually operating the driving member to drive the heat pressing member to abut against the workpiece to be processed.

When the workpiece is placed by the user, the support base 120 can be driven to slide relative to the base body 110 and move the support base 120 away from the heat pressing assembly 300, thereby avoiding burns from the heat pressing assembly 300 during the placement of the workpiece to be processed. Additionally, the driving member 320 can be manually operated, allowing the user to more easily adjust a force of heat pressing according to different workpieces to be processed, while also providing the enjoyment of manual operation.

When the heat press machine is provided with an adjusting assembly 500, the user can also control the lifting and lowering of the heat pressing assembly 300 through the adjusting assembly 500, making operation more convenient and the movement of the heat pressing assembly 300 smoother.

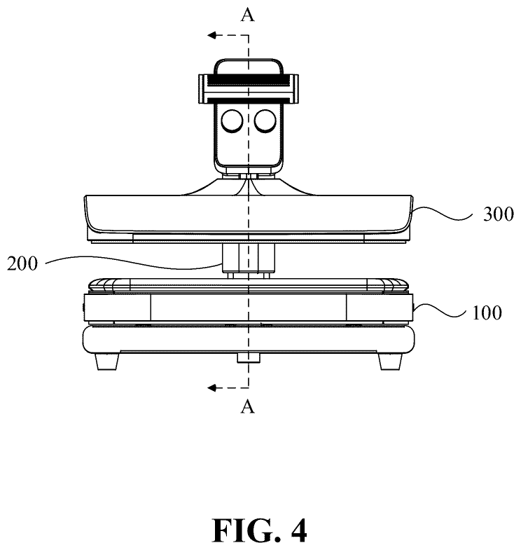

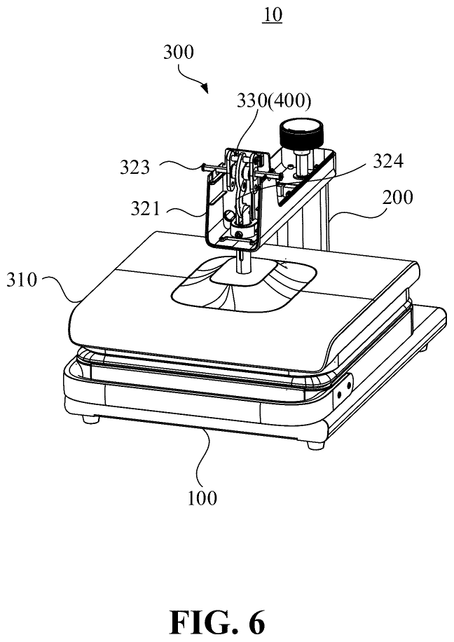

Referring to FIGS. 4 to 7, in an embodiment, the heat press machine 10 further comprises position detection modules 330, the position detection modules 330 being configured to detect a working position of the heat pressing member 310 during the heat pressing of the workpiece to be processed. The driving member 320 of the heat press machine 10 is manually operated to drive the heat pressing member 310 to press against the workpiece to be processed, which may lead to the heat pressing member 310 not being properly positioned, causing either a lack of force or excessive force. The position detection module detects whether the heat press element 310 has reached the working position and generates corresponding reminder information. The user can receive effective feedback, allowing them to either continue applying force or stop applying force.

It should be noted that the working position can be adjusted according to different workpieces or different transfer printing effects.

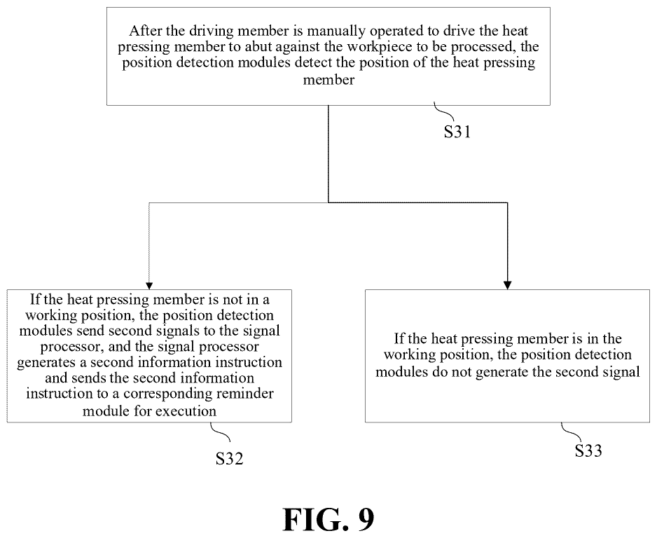

Referring to FIG. 9, correspondingly, the method further includes a heat pressing member 310 heat-pressing in-position reminder step, specifically as follows:
Step S31, after the driving mechanism is manually operated to drive the heat pressing member to abut against the workpiece to be processed., the position detection modules detect the position of the heat pressing member;
Step S32, if the heat pressing member is not in the working position, the position detection modules send second signals to a signal processor, and the signal processor generates a second information instruction and sends the second information instruction to a corresponding reminder module for execution; and
Step S33, if the heat pressing member is in the working position, the position detection modules do not generate the second signal.

When the user manually operates the handle 322 to drive the heat pressing member 310 to press downward but fails to position it properly, the heat press machine 10 can generate a corresponding signal to remind the user to continue applying force in order to achieve a better heat transfer printing effect. The details of the downward pressing reminder function can be referred to in the previous description of the position detection modules 330.

Specifically, in this embodiment, the position detection modules 330 are contact sensors 400, and the contact sensors 400 are arranged within the driving member 320. When the driving member 320 drives the heat pressing member 310 to move to the working position, at least part of the driving member 320 abuts against the contact sensors 400. The contact sensors 400 generate corresponding signals to a control mainboard (signal processing module). The control mainboard generates corresponding reminder information. The reminder information may include voice reminders, lighting effects, display content on a display screen 600, etc.

It should be noted that in other embodiments, the position detection modules 330 may also be infrared sensors, laser sensors, image sensors, or other types of sensors.

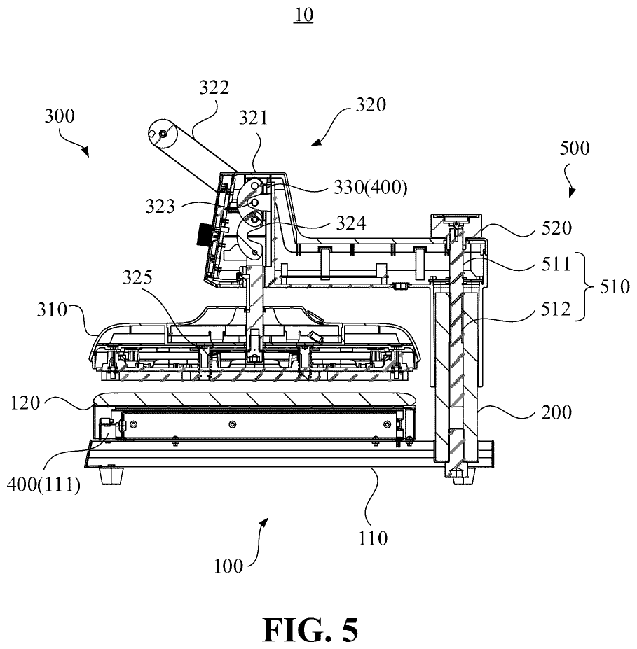

Referring to FIGS. 5, 6 and 7, specifically, the driving member 320 comprises a housing 321, a handle 322, a mounting shaft 323 and a crankshaft structure 324, where both opposite ends of the mounting shaft 323 respectively pass through the housing 321, the handle 322 is connected to two opposite ends of the mounting shaft 323, the handle 322 is operated manually, and both opposite ends of the crankshaft structure 324 are respectively connected to the handle 322 and the heat pressing member 310. The user can operate the handle 322 to rotate, driving the crankshaft structure 324 to move, and causing the heat pressing member 310 to move closer to or away from the support base 120.

The housing 321 can protect at least part of the mounting shaft 323 and crankshaft structure 324 arranged within the housing 321, preventing interference from debris during movement and enhancing user safety.

It can be understood that when the user rotates the handle 322 in a forward direction, the crankshaft structure 324 drives the heat pressing member 310 to move toward the support base 120, while a heat pressing structure (e.g., a heating wire) inside the heat pressing member 310 heats up. The heat pressing member 310 then presses down on the workpiece on the support base 120 for processing, transferring the patterns or text from the heat transfer film to the workpiece. After the transfer printing is completed, the user can rotate the handle 322 in a reverse direction, causing the crankshaft structure 324 to drive the heat pressing member 310 to move away from the support base 120. Additionally, the user can slide the support base 120 away from the heat pressing assembly 300 to avoid being burned by the heat pressing member 310.

It can be understood that in other embodiments, the handle 322 may be replaced with other structures that can be operated by the user, such as a pressure rod. The structure operated by the user is not limited in the present disclosure.

Further, the crankshaft structure 324 comprises crankshafts 3241, a connecting shaft 3242, a connecting rod 3243 and a sliding rod 3244, where the crankshafts 3241 are sleeved on the mounting shaft 323; both ends of the connecting shaft 3242 in an axial direction are respectively connected to the crankshafts 3241 on both sides; the connecting rod 3243 is sleeved on the connecting shaft 3242, and the sliding rod 3244 is rotatably connected to the end of the connecting rod 3243 away from the connecting shaft 3242; and the user can rotate the handle 322, which sequentially drives the crankshafts 3241 and the connecting rod 3243, and the connecting rod 3243 drives the sliding rod 3244 to move in a height direction.

In this embodiment, the rotation of the handle 322 sequentially drives the mounting shaft 323, the crankshafts 3241, and the connecting shaft 3242. The connecting shaft 3242 drives the connecting rod 3243, which in turn drives the sliding rod 3244 to move in the height direction, thus converting the rotation of the handle 322 into linear motion of the sliding rod 3244. As a result, the reciprocating motion of the heat pressing member 310 in the height direction can be made smoother by the sliding rod 3244.

It can be understood that in other embodiments, the direction of movement of the sliding rod 3244 may also be inclined relative to the height direction, and a motion trajectory of the sliding rod 3244 may also be a curve or an angular line, etc. The manufacturer can freely adjust the positional relationship between the support 200 and the heat pressing assembly 300 as needed to change the motion trajectory of the sliding rod 3244.

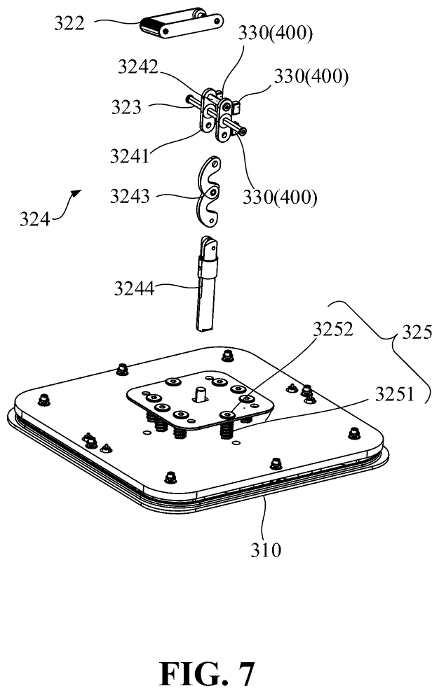

Referring to FIG. 7, specifically, the connecting rod 3243 is a double-C-shaped connecting rod, with an overall shape roughly resembling two letters C connected head-to-tail. This configuration allows for smoother movement of the sliding rod 3244, while also providing a greater range of movement for the user to manually drive the sliding rod 3244, and preventing interference between the connecting rod 3243 and the mounting shaft 323. Of course, in other embodiments, the connecting rod 3243 may be replaced with other shapes, such as a V-shape, as long as the technical solution that converts the rotation of the handle 322 into linear motion to drive the sliding rod 3244 falls within the scope of protection of the present disclosure.

Further, the positions of the contact sensors 400 are adapted to the positions of the crankshafts 3241. When the driving member 320 drives the heat pressing member 310 to move to the working position, at least part of the crankshafts 3241 abut against the contact sensors 400 and apply a force to the contact sensors 400, so that the contact sensors 400 are triggered.

In other words, in this embodiment, the heat press machine 10 determines whether the heat pressing member 310 has been properly pressed down by detecting the positions of the crankshafts 3241 after the rotation. If it is detected that the heat pressing member has been properly pressed down, the user is reminded to continue applying force. A specific reminder method may be in the form of images or text displayed on the display screen 600, voice reminders, light flashing, etc.

Of course, in other embodiments, the positions of the connecting rod 3243, the sliding rod 3244, or other components during the movement of the heat pressing member 310 can also be detected to determine whether the heat pressing member has been properly pressed down. The specific detection methods may include image detection, infrared detection, etc.

In this embodiment, two crankshafts 3241 are provided, and each crankshaft 3241 corresponds to two spaced contact sensors 400. The crankshafts 3241 are respectively positioned at both ends of the mounting shaft 323 in the axial direction. The position of each contact sensor 400 is adapted to the position of the corresponding crankshaft 3241, and the two contact sensors 400 are spaced apart along the height direction of the crankshaft 3241.

By detecting the positions of the two parallel crankshafts 3241 after rotation, the misjudgment of the pressing position caused by sideways misalignment of a crankshaft 3241 assembly can be avoided, thereby improving the judgment accuracy of the pressing position. In addition, a transmission direction from the handle 322 to the sliding rod 3244 can also be detected and maintained, preventing misalignment of the heat pressing member 310 and ensuring that all areas are properly transferred, thus ensuring the heat transfer printing effect.

In addition, each crankshaft 3241 corresponds to two contact sensors 400, which can not only detect whether the heat pressing has reached a correct position but also detect whether the handle 322 has been reset.

Referring to FIGS. 5 and 7, specifically, the driving member 320 further comprises a cushioning structure 325. The cushioning structure 325 is arranged between the sliding rod 3244 and the heat press machine 10. The cushioning structure 325 is capable of reducing the force exerted by the sliding rod 3244 on the heat press machine 10, thus achieving a cushioning effect. As a result, when the handle 322 is operated to drive the heat pressing member 310 to perform heat pressing on the workpiece, under the action of the cushioning structure 325, the pressure exerted by the heat pressing member 310 on the workpiece will not be too high, preventing damage to the workpiece.

In this embodiment, the cushioning structure 325 comprises springs 3251 and guide posts 3252. The springs 3251 are sleeved on the guide posts 3252. A plurality of springs 3251 and a plurality of guide posts 3252 are provided. The plurality of guide posts 3252 are arranged at intervals and around the sliding rod 3244. Thus, when the handle 322 is rotated in the forward direction, the springs 3251 are compressed, so that the cushioning structure 325 can more smoothly apply a force to the heat pressing member 310.

It can be understood that in other embodiments, the cushioning structure 325 may be replaced with other components that can deform and steadily apply a cushioning force, such as rubber buffers, gas-hydraulic buffers, etc.

Referring to FIGS. 3 and 5, in one embodiment, the heat press machine 10 further comprises an adjusting assembly 500, where two opposite ends of the adjusting assembly 500 are respectively connected to the heat pressing assembly 300 and the support 200, and the adjusting assembly 500 is configured to adjust a distance between the heat pressing assembly 300 and the support base 120. Thus, the user can adjust the distance between the heat pressing assembly 300 and the support base 120 through the adjusting assembly 500, and then operate the handle 322 to cause the heat pressing member 310 to press against the workpiece on the support base 120. This allows the user to more easily control the pressure exerted by the heat pressing member 310 on the workpiece, resulting in a smoother force applied to the workpiece and better heat transfer printing effects.

Specifically, the adjusting assembly 500 comprises a screw rod 510 and a knob 520, where the screw rod 510 comprises a connecting end 511 and a threaded end 512, the threaded end 512 is in threaded connection with the support 200, and the connecting end 511 passes through one end of the heat pressing assembly 300 and is fixedly connected to the knob 520. The user can rotate the knob 520 in the forward direction or the reverse direction to drive the rotation of the screw rod 510. The threaded end 512 of the screw rod 510 is in screw-thread fit with the support 200, causing the heat pressing assembly 300 to move upward or downward.

Thus, through the cooperation between the knob 520, the screw rod 510, and the support 200, the rotational motion of the knob 520 is converted into linear motion of the screw rod 510, so that the heat pressing assembly 300 can rise and fall smoothly, thereby adjusting the distance between the heat pressing member 310 and the support base 120.

In this embodiment, to increase friction, anti-slip patterns are provided on an outer sidewall of the knob 520 and extend circumferentially along the knob 520.

Further referring to FIGS. 3 and 5, in this embodiment, sliding rails 112 are arranged on both opposite sides of the base body 110, and sliding portions 121 that are adapted to the sliding rails 112 are arranged on both opposite sides of the support base 120. The sliding portions 121 slide along the sliding rails 112 to drive the support base 120 to slide relative to the base body 110. Thus, the support base 120 can slide smoothly and steadily on the base body 110, making it more convenient for the user to pick and place workpieces.

In one embodiment, as shown in FIG. 5, the base body 110 is provided with an in-position detection module 111, and the in-position detection module 111 is configured to detect the position of the support base 120 relative to the base body 110. It can be understood that after placing the workpiece to be processed on the support base 120, the user needs to push the support base 120 to slide and align the workpiece with the heat pressing member 310. The provision of the in-position detection module 111 can prevent misalignment between the heat pressing member and the support base 120 caused by the user not pushing the support base 120 fully into position, thereby ensuring the heat transfer printing effect.

Specifically, the in-position detection module 111 is a contact sensor 400. When the sliding portions 121 slide relative to the sliding rails 112 to cause the support base 120 to slide to a preset position, at least part of the support base 120 abuts against the contact sensor 400 and applies a force to the contact sensor 400, so that the contact sensor 400 is triggered. It can be understood that the preset position in this embodiment refers to the position of the support base 120 relative to the base body 110 when the heat pressing member 310 is aligned with the support base 120. Of course, in other embodiments, the manufacturer can adjust the preset position as needed.

In other words, in this embodiment, the heat press machine 10 determines whether the support base 120 is in position by determining whether the support base 120 makes contact with the contact sensors 400. If it is detected that the support base 120 is not in position, the user will be reminded to continue moving the support base to the correct position. The specific reminder method may be an image or text displayed on the display screen 600, voice reminders, light flashing reminders, etc. In this embodiment, the heat press machine 10 is configured with both backlight flashing and a “beep” sound reminder for the support seat 120 position reminder.

Of course, in other embodiments, other detection methods such as image detection or infrared detection can also be used to determine whether the support base 120 is in position.

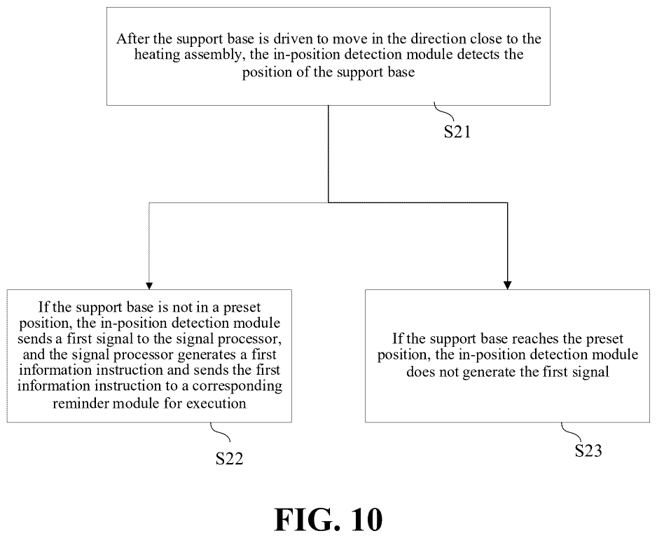

Referring to FIG. 10, correspondingly, the method further includes a support base 120 heat-pressing in-position reminder step, specifically as follows:
Step S21, after the support base is driven to move in the direction close to the heat pressing assembly, the in-position detection module detects the position of the support base;
Step S22, if the support base is not in a preset position, the in-position detection module sends a first signal to the signal processor, and the signal processor generates a first information instruction and sends the first information instruction to a corresponding reminder module for execution; and
Step S23, if the support base reaches the preset position, the in-position detection module does not generate the first signal.

The user can accurately align the support base 120 with the heat pressing member 310 using the support base 120 in-position reminder function of the heat press machine 10. The details of the in-position reminder step can refer to the previous description of the in-position detection module 111.

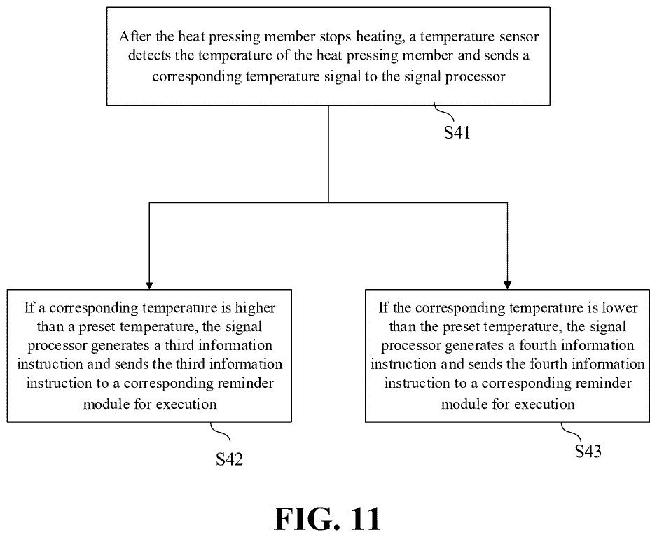

Referring to FIG. 11, in one embodiment, the method further includes a residual heat reminder function, specifically as follows:
Step S41, after the heat pressing member stops heating, a temperature sensor detects the temperature of the heat pressing member and sends a corresponding temperature signal to the signal processor;
Step S42, if a corresponding temperature is higher than a preset temperature, the signal processor generates a third information instruction and sends the third information instruction to a corresponding reminder module for execution; and
Step S43, if the corresponding temperature is lower than the preset temperature, the signal processor generates a fourth information instruction and sends the fourth information instruction to a corresponding reminder module for execution.

After the heat transfer printing is completed, a power supply of the heat pressing member 310 is turned off, but the heat pressing member 310 still retains residual heat. The user may get burned if the user touches the heat press machine 10.

Therefore, by setting a residual heat reminder function, after the heat pressing member 310 is powered off, the temperature of the heat pressing member 310 is detected by the temperature sensor and displayed in real time on the display screen 600. At the same time, the brightness of the display screen 600 dims. When the temperature of the heat pressing member 310 drops below 50° C., the display screen 600 turns off completely and no longer displays the real-time temperature. Of course, in other embodiments, the manufacturer can adjust the preset temperature to 35° C., 40° C., 45° C., etc.

It should be noted that in the working method of the second aspect, the reminder modules may be any one of a voice module, a lighting module, or the display screen 600, or any combination thereof.

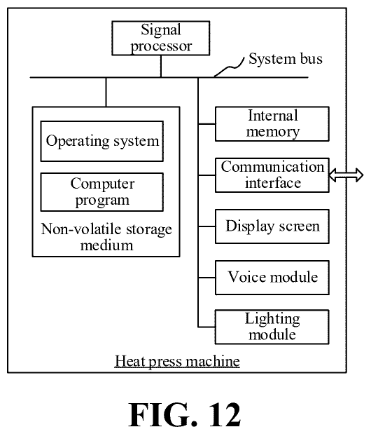

Referring to FIG. 12, it should be noted that in some embodiments, the manufacturer may configure the heat press machine 10 with a signal processor, a display screen 600, a temperature sensor, a voice module, or a lighting module, as needed. The signal processor may be a circuit mainboard, etc. The display screen 600, the temperature sensor, and the voice module or the lighting module are electrically connected to the signal processing module. The electrical connection may be a wired connection or a wireless signal connection. The display screen 600 is configured to display various images or text, the temperature sensor is configured to detect the temperature of the heat pressing member 310, the voice module is capable of emitting voice or interacting with the user via voice, and the lighting module includes light-emitting elements that can create flashing or color-changing lighting effects.

A computer program may be stored in a non-volatile computer-readable storage medium. When executed, the computer program may include processes such as those described in the embodiments of the methods above. Any reference to a memory, storage, database, or other medium used in the embodiments of the present disclosure may include at least one of non-volatile and volatile memories. The non-volatile memory may include read-only memory (ROM), magnetic tapes, floppy disks, flash memory, optical storage, etc. The volatile memory may include a random-access memory (RAM) and an external cache memory.

Although the present disclosure has been described with reference to several exemplary embodiments, it should be understood that the terms used are illustrative and exemplary, not limiting. Since the present disclosure can be embodied in various forms without departing from the spirit or essence of the present disclosure, it should be understood that the above embodiments are not limited to the specific details mentioned and should be broadly interpreted within the spirit and scope defined by the appended claims. Therefore, all variations and modifications that fall within the scope of the claims or their equivalents should be covered by the appended claims.

What is claimed is:

1. A heat press machine, comprising:
a base, the base comprising a base body and a support base slidably connected to the base body, and the support base being configured to carry a workpiece to be processed;
a support, the support being connected to the base; and
a heat pressing assembly connected to the end of the support away from the base, wherein the heat pressing assembly comprises a heat pressing member arranged opposite the support base and a driving member configured to drive the heat pressing member, and the driving member is operable manually.

2. The heat press machine according to claim 1, further comprising position detection modules, wherein the position detection modules are configured to detect a working position of the heat pressing member.

3. The heat press machine according to claim 2, wherein the position detection modules are contact sensors, and the contact sensors are disposed in the driving member; and
when the driving member drives the heat pressing member to move to the working position, at least part of the driving member abuts against the contact sensors.

4. The heat press machine according to claim 3, wherein the driving member comprises a housing, a handle, a mounting shaft and a crankshaft structure; and two opposite ends of the mounting shaft respectively pass through the housing, the handle is connected to the two opposite ends of the mounting shaft and is configured for manual operation, two opposite ends of the crankshaft structure are respectively connected to the handle and the heat pressing member, and under the action of an external force, the handle drives the crankshaft structure to move, thereby driving the heat pressing member to approach or move away from the support base.

5. The heat press machine according to claim 4, wherein the crankshaft structure comprises crankshafts, a connecting shaft, a connecting rod and a sliding rod; and the crankshafts are sleeved on the mounting shaft, both ends of the connecting shaft in an axial direction are respectively connected to the crankshafts and the connecting rod, the sliding rod is rotatably connected to the end of the connecting rod away from the connecting shaft, and the handle is rotated to drive the heat pressing member to move in a height direction via the crankshafts, the connecting rod and the sliding rod.

6. The heat press machine according to claim 5, wherein the positions of the contact sensors are adaptive to the positions of the crankshafts, and when the driving member drives the heat pressing member to move to the working position, at least part of the crankshafts abut against the contact sensors.

7. The heat press machine according to claim 6, wherein two crankshafts are provided and respectively located at both ends of the mounting shaft in the axial direction, and two spaced contact sensors are arranged corresponding to each crankshaft.

8. The heat press machine according to claim 5, wherein the driving member further comprises a cushioning structure arranged between the sliding rod and the heat pressing member.

9. The heat press machine according to claim 1, further comprising an adjusting assembly, wherein two opposite ends of the adjusting assembly are respectively connected to the heat pressing assembly and the support, and the adjusting assembly is configured to adjust a distance between the heat pressing assembly and the support base.

10. The heat press machine according to claim 9, wherein the adjusting assembly comprises a screw rod and a knob, the screw rod comprises a connecting end and a threaded end, the threaded end is in threaded connection with the support, and the connecting end passes through one end of the heat pressing assembly and is fixedly connected to the knob.

11. The heat press machine according to claim 1, wherein the base body is provided with sliding rails, the support base is provided with sliding portions adapted to the sliding rails, and the sliding portions slide on the sliding rails to drive the support base to slide relative to the base body; and
the base body is further provided with an in-position detection module, and the in-position detection module is configured to detect the position of the support base relative to the base body.

12. The heat press machine according to claim 11, wherein the in-position detection module is a contact sensor, and when the sliding portions slide relative to the sliding rails to drive the support base to slide to a preset position, at least part of the support base abuts against the contact sensor.

13. The heat press machine according to claim 1, further comprising:
a signal processor; and/or,
a display screen electrically connected to the signal processor; and/or,
a temperature sensor configured to detect the temperature of the heat pressing member; and/or,
a voice module; and/or,
a lighting module configured to display a lighting effect.

14. A working method for the heat press machine according to claim 1, comprising the following steps:
driving the support base to move relative to the base body in a direction away from the heat pressing assembly;
placing the workpiece to be processed and a material to be transferred onto the support base, and driving the support base to move in a direction close to the heat pressing assembly; and
manually operating the driving member to drive the heat pressing member to abut against the workpiece to be processed.

15. The method according to claim 14, further comprising a support base in-position reminder step, specifically as follows:
after driving the support base to move in the direction close to the heat pressing assembly, the in-position detection module detects the position of the support base;
If the support base is not in a preset position, the in-position detection module sends a first signal to the signal processor, and the signal processor generates a first information instruction and sends the first information instruction to a corresponding reminder module for execution; and
if the support base reaches the preset position, the in-position detection module does not generate the first signal.

16. The method according to claim 14, further comprising a heat-pressing in-position reminder step, specifically as follows:
after the driving member is manually operated to drive the heat pressing member to abut against the workpiece to be processed, the position detection modules detect the position of the heat pressing member;
if the heat pressing member is not in a working position, the position detection modules send second signals to the signal processor, and the signal processor generates a second information instruction and sends the second information instruction to a corresponding reminder module for execution; and
if the heat pressing member is in the working position, the position detection modules do not generate the second signal.

17. The method according to claim 14, further comprising a residual heat reminder step, specifically as follows:
after the heat pressing member stops heating, a temperature sensor detects the temperature of the heat pressing member and sends a corresponding temperature signal to the signal processor;
if a corresponding temperature is higher than a preset temperature, the signal processor generates a third information instruction and sends the third information instruction to a corresponding reminder module for execution; and
if the corresponding temperature is lower than the preset temperature, the signal processor generates a fourth information instruction and sends the fourth information instruction to a corresponding reminder module for execution.

18. The method according to any one of claims 17, wherein the reminder module is any one or any combination of a voice module, a lighting module, and a display screen.
